(19) United States
(12) Patent Application Publication
(10) Pub. No.: US 2017/0159442 A1
(43) Pub. Date: Jun. 8, 2017

(54) COATED AND UNCOATED SURFACE-MODIFIED AIRFOILS FOR A GAS TURBINE ENGINE COMPONENT AND METHODS FOR CONTROLLING THE DIRECTION OF INCIDENT ENERGY REFLECTION FROM AN AIRFOIL

(71) Applicant: UNITED TECHNOLOGIES CORPORATION, Hartford, CT (US)

(72) Inventors: MIGUEL ANGEL VELAZQUEZ, JR., Wethersfield, CT (US); ADAM M. ROSENKRANTZ, Newington, CT (US); ROCCO S. CUVA, South Glastonbury, CT (US)

(73) Assignee: UNITED TECHNOLOGIES CORPORATION, Hartford, CT (US)

(21) Appl. No.: 14/957,208

(22) Filed: Dec. 2, 2015

(51) Int. Cl. F01D 5/14; F01D 5/28

(52) U.S. Cl. CPC F01D 5/141; F01D 5/288; F05D 2220/32; F05D 2230/50; F05D 2240/301; F05D 2250/11; F05D 2250/12; F05D 2250/232

(57) ABSTRACT

A surface-modified airfoil for a gas turbine engine component is provided. The surface-modified airfoil includes an airfoil having an exterior surface at a leading edge, a trailing edge, a suction side, and a pressure side. A surface feature in at least a portion of the exterior surface comprises at least one of a protrusion feature or a depression feature. The surface feature is operatively configured for one of anchoring a coating on at least the portion of the exterior surface or controlling a direction of incident energy reflected from the surface-modified airfoil.

### FIELD

The present disclosure relates to gas turbine engines, and more specifically, to coated and uncoated surface-modified airfoils for a gas turbine engine component, and methods for controlling the direction of incident energy reflection from an airfoil.

### BACKGROUND

A gas turbine engine typically includes a fan section, a compressor section, a combustor section, a turbine section, and an exhaust section. Air entering the compressor section is compressed and delivered into the combustion section where it is mixed with fuel and ignited to generate a high-speed exhaust flow. The high-speed exhaust gas flow expands through the turbine section to drive the compressor and the fan section and then exits out the exhaust section.

Airfoils used on rotor blades and static vanes may be surface coated but the coating may not adhere well. Moreover, some coatings perform optimally with varying levels of coating thickness, but such varying levels of coating thickness detract from having a smooth contact surface for unperturbed airflow across the airfoil. In addition, managing the direction of incident energy reflection from the airfoils may be beneficial for certain applications.

### SUMMARY

A surface-modified airfoil for a gas turbine engine component is provided, according to various embodiments. The surface-modified airfoil includes an airfoil having an exterior surface at a leading edge, a trailing edge, a suction side, and a pressure side. A surface feature in at least a portion of the exterior surface comprises at least one of a protrusion feature or a depression feature. The surface feature is operatively configured for one of anchoring a coating on at least the portion of the exterior surface or controlling a direction of incident energy reflected from the surface-modified airfoil.

A gas turbine engine component is provided, according to various embodiments. The gas turbine engine component comprises a surface-modified airfoil. The surface-modified airfoil comprises an airfoil having an exterior surface at a leading edge, a trailing edge, a suction side, and a pressure side. A surface feature in at least a portion of the exterior surface comprises at least one of a protrusion feature or a depression feature.

A method is provided for controlling a direction of incident energy reflection from an airfoil of a gas turbine engine component, according to various embodiments. The method comprises determining a desired path for the incident energy reflection. A size, orientation, and shape of a surface feature in at least a portion of an exterior surface of the airfoil are predetermined to controllably direct the incident energy reflection to the desired path. A surface-modified airfoil is formed having the surface feature of the predetermined size, orientation, and shape.

In any of the foregoing embodiments, the surface feature partially extends between the leading edge and the trailing edge. The surface feature is localized on the exterior surface of at least one of the leading edge of the airfoil, the trailing edge of the airfoil, a position upstream from the trailing edge of the airfoil, a position downstream from the leading edge of the airfoil, on the pressure side of the airfoil, or on the suction side of the airfoil. The surface feature comprises other than a groove and extends continuously from the leading edge to the trailing edge of the airfoil, on at least one of the pressure side or the suction side of the airfoil. The surface feature at least one of projects above a nominal airfoil surface or is within the nominal airfoil surface. The surface feature has at least one of a cross-sectional shape comprising a triangular shape, a rectangular shape, a saw-tooth shape, a sine shape, a conical shape, or a dove tail shape. The surface feature is arranged in a straight line and has an orientation in one direction or a curved orientation in one or more directions. The surface feature has at least one of a selected depth, a selected spacing, or a selected periodicity. The surface feature is selected to have a predetermined size, orientation, and cross-sectional shape to control the direction of incident energy reflected from the surface-modified airfoil. The surface-modified airfoil further comprises the coating on at least the portion of the airfoil. The surface feature comprises a groove extending from the leading edge to the trailing edge. The coating at least partially fills the surface feature. Forming a surface-modified airfoil comprises forming the surface feature in at least one portion of the exterior surface of the airfoil. Forming the surface feature in the at least one portion comprises forming the surface feature in a selected portion that at least partially extends between a leading edge and a trailing edge of the airfoil or localized on the exterior surface of the airfoil on at least one of the leading edge of the airfoil, the trailing edge of the airfoil, a position upstream from the trailing edge of the airfoil, a position downstream from the leading edge of the airfoil, on the pressure side of the airfoil, or on the suction side of the airfoil.

### BRIEF DESCRIPTION OF THE DRAWINGS

FIG. 1A is a schematic view of an exemplary gas turbine engine component and FIGS. 1B and 1C are different views of the airfoil of the gas turbine engine component of FIG. 1A;

FIG. 2A is a schematic isometric view of an exemplary surface-modified airfoil and FIG. 2B is a sectional view of the exemplary surface-modified airfoil of FIG. 2A taken along the line B-B thereof, according to various embodiments;

FIG. 2C is a schematic isometric view of an exemplary surface-modified airfoil similar to FIG. 2A, illustrating different orientations and directions of exemplary surface features, according to various embodiments;

FIGS. 2D and 2E are schematic isometric views of exemplary surface-modified airfoils, according to various embodiments;

FIG. 3 is a schematic isometric view of a generic surface-modified airfoil, FIG. 3A is a sectional view of the exemplary generic surface-modified airfoil of FIG. 3 taken along the line A-A thereof, with FIGS. 3B through 3H illustrating various cross-sectional shapes for a surface feature of the surface-modified airfoil, according to various embodiments;

FIG. 4A is a sectional view of FIG. 3 taken along line A-A thereof and FIGS. 4B through 4D are also sectional views illustrating the relationship of the surface feature with the nominal airfoil surface (NAS), according to various embodiments;

FIG. 5 is the same sectional view of the surface-modified airfoil of FIG. 4D, illustrating spacing and depth measurements for the surface feature, according to various embodiments;

FIG. 6 is a sectional view of an exemplary surface-modified airfoil, illustrating an exemplary periodicity measurement for the periodicity feature;

FIG. 7 is a schematic isometric view of an exemplary coated surface-modified airfoil, according to various embodiments;

FIGS. 8A through 8C are sectional views of an exemplary coated surface-modified airfoil, illustrating the different fill levels of the coating, according to various embodiments;

FIG. 9 is a schematic isometric view of an exemplary coated surface-modified airfoil, according to various embodiments;

FIG. 10A is a schematic view of an energy wave incident upon a conventional airfoil having a non-modified smooth external contact surface and FIG. 10B is a schematic view of the energy wave incident on a surface-modified airfoil according to various embodiments; and

FIG. 11 is a flow diagram of a method for controlling the direction of incident energy reflection from an airfoil, according to various embodiments.

The subject matter of the present disclosure is particularly pointed out and distinctly claimed in the concluding portion of the specification. A more complete understanding of the present disclosure, however, may best be obtained by referring to the detailed description and claims when considered in connection with the drawing figures, wherein like numerals denote like elements.

### DETAILED DESCRIPTION

The detailed description of exemplary embodiments herein makes reference to the accompanying drawings, which show exemplary embodiments by way of illustration. While these exemplary embodiments are described in sufficient detail to enable those skilled in the art to practice the inventions, it should be understood that other embodiments may be realized and that logical changes and adaptations in design and construction may be made in accordance with the present inventions and the teachings herein. Thus, the detailed description herein is presented for purposes of illustration only and not of limitation. The scope of the present inventions is defined by the appended claims. For example, the steps recited in any of the method or process descriptions may be executed in any order and are not necessarily limited to the order presented. Furthermore, any reference to singular includes plural embodiments, and any reference to more than one component or step may include a singular embodiment or step. Also, any reference to attached, fixed, connected or the like may include permanent, removable, temporary, partial, full and/or any other possible attachment option. Additionally, any reference to without contact (or similar phrases) may also include reduced contact or minimal contact.

Various embodiments are directed to coated and uncoated surface-modified airfoils for a gas turbine engine component, and methods for controlling the direction of incident energy reflection from an airfoil. The airfoil surface is modified in a manner that helps one or more coatings adhere thereto, helps control the direction of incident energy reflection therefrom and/or, specifically for the coated surface-modified airfoils, provides a substantially smooth contact surface for aerodynamic purposes but with varying coating thickness levels. While reference to “modification” of the airfoil surface is described, it is to be understood that the airfoil may be fabricated by casting or other manufacturing methods by which the surface “modification” is made during fabrication itself, rather than by modification of an existing airfoil.

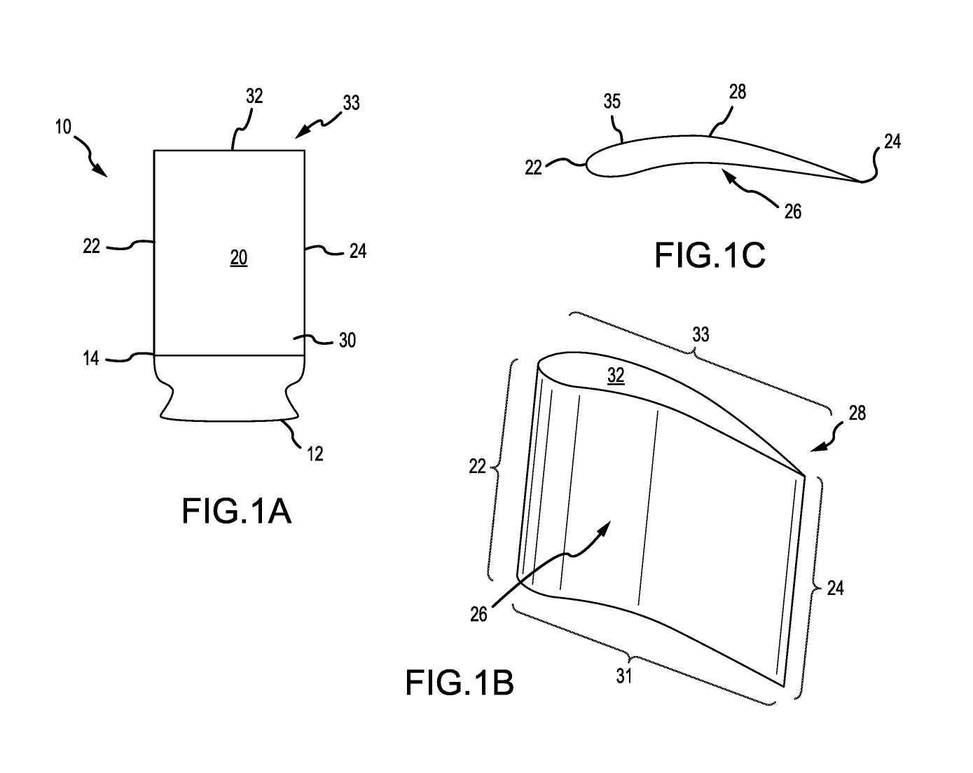

Referring now to FIGS. 1A through 1C, a gas turbine engine component 10 such as a turbine blade comprises an airfoil portion (or simply “airfoil”) 20 that protrudes outwardly from a fir tree attachment 12. A blade platform 14 (shown schematically in FIG. 1A) may be disposed between the airfoil 20 and the fir tree attachment 12, i.e., the airfoil extends radially outwardly from an outer surface of the blade platform and the fir tree attachment extends radially inwardly from an inner surface of the blade platform. The airfoil 20 has a leading edge 22 and a trailing edge 24, a pressure side 26 and a suction side 28, a root 30 at an inner diameter 31 and a tip 32 at an outer diameter 33. The airfoil 20 also has an exterior surface 35.

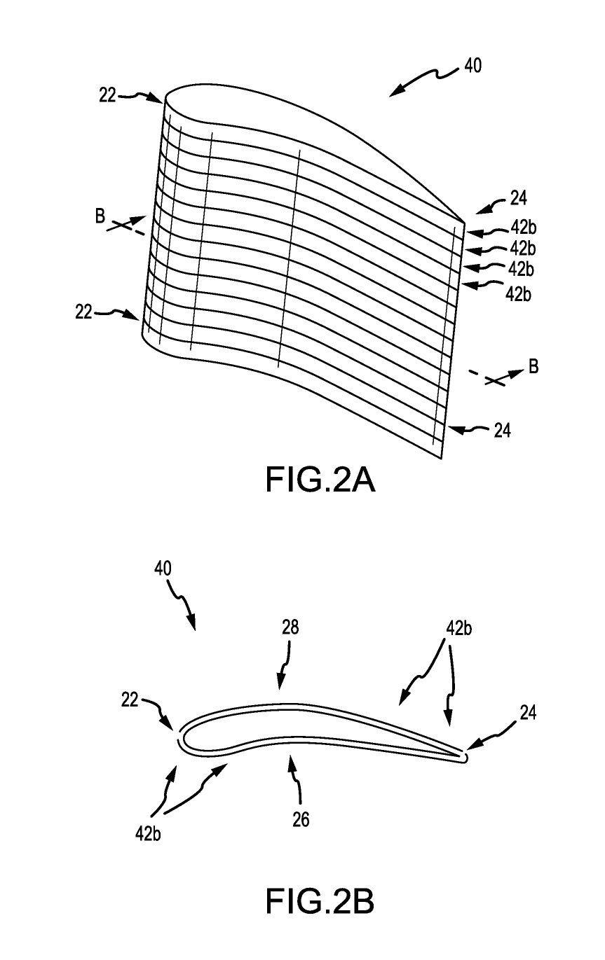

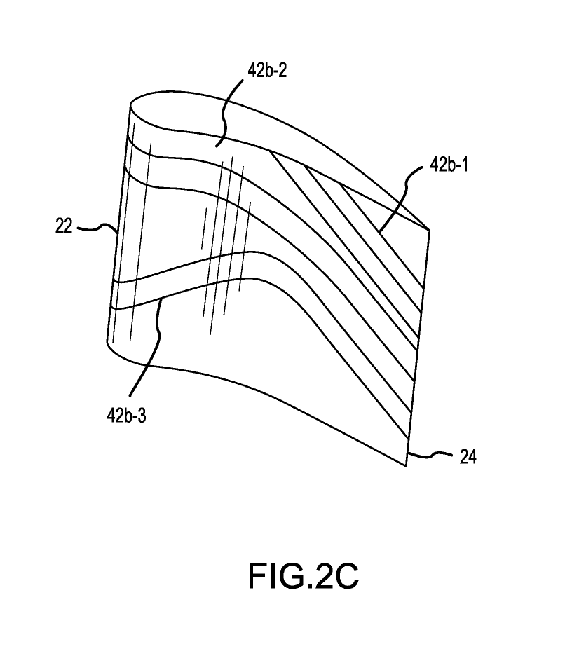

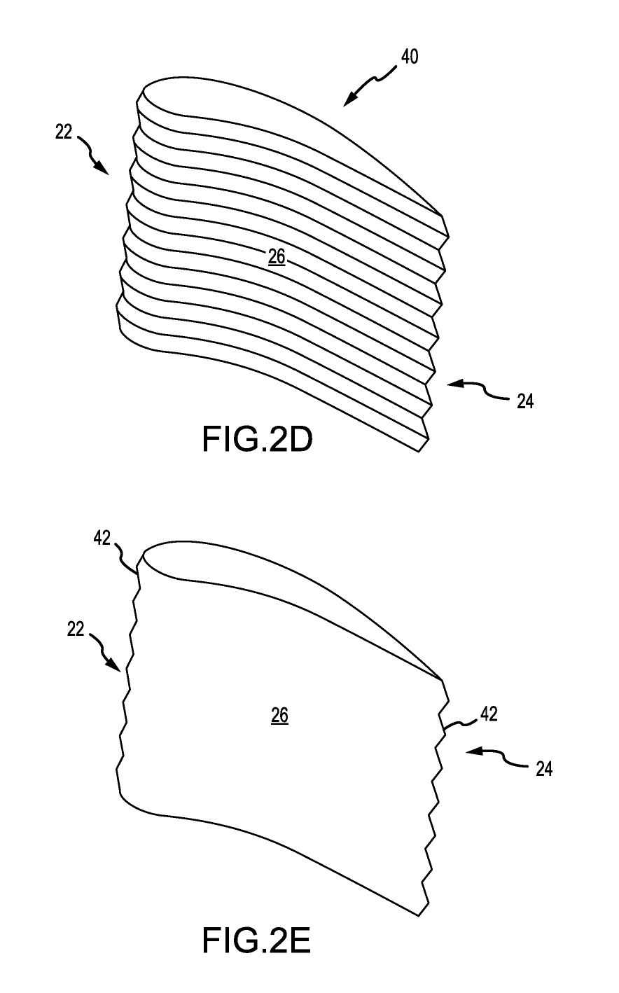

Referring now to FIG. 2A illustrating an exemplary surface-modified airfoil 40 and to FIG. 2B illustrating a section thereof taken along line B-B of FIG. 2A, according to various embodiments, the surface-modified airfoil 40 comprises the airfoil 20 as previously described and a surface feature (e.g., protrusion feature 42a and/or depression feature 42b) in at least a portion of the exterior surface 35 of the airfoil. As used herein, the term “surface feature” includes one or more surface features. The surface feature may comprise at least one of the protrusion feature 42a or the depression feature 42b. As used herein, the term “protrusion feature” includes one or more protrusion features and the term “depression feature” includes one or more depression features. The protrusion feature generally comprises convex edges while a depression feature has concave edges. The protrusion feature comprises at least one of a boss, a rib, a bump, or the like. The depression feature comprises at least one of a hole, slot, pocket, a groove, or the like. A concave surface curves inward. For example, a concave indentation in a wall makes a cave. A convex surface curves outward. The surface feature may be in a selected portion of the exterior surface of the airfoil 20. For example, the surface feature (more particularly, the one or more surface features) may partially extend between the leading edge 22 and the trailing edge 24 of the airfoil 20. The surface feature may be localized at the leading edge of the airfoil, the trailing edge of the airfoil, a position upstream from the trailing edge of the airfoil, a position downstream from the leading edge of the airfoil, on the pressure side of the airfoil, on the suction side of the airfoil, and combinations thereof. As used herein, the term “downstream” refers to the direction of flow across the airfoil and the term “upstream” refers to the opposite direction of the direction of flow. If the surface feature is other than one or more grooves, the surface feature may extend continuously from the leading edge to the trailing edge of the airfoil, on one or both of the pressure side and the suction side of the airfoil. In FIGS. 2A and 2B, a plurality of depression features (as exemplified by grooves) 42b are shown extending from the leading edge 22 to the trailing edge 24 of the airfoil on both the pressure side 26 and the suction side 28. FIG. 2A also illustrates that the surface feature may be arranged in a straight line, oriented in only one direction. FIG. 2C illustrates another exemplary surface-modified airfoil according to various embodiments. In FIG. 2C, the surface-modified airfoil comprises exemplary surface features arranged in a straight line (collectively designated as depression features 42b-1) (such as depicted in FIG. 2A), exemplary surface features with a curved orientation (collectively designated as depression features 42b-2), and exemplary surface features with a curved orientation in greater than one direction (collectively designated as depression features 42b-3). FIGS. 2D and 2E each illustrate a different exemplary surface-modified airfoil 40, according to various embodiments. The surface-modified airfoil 40 of FIG. 2D includes surface features at the leading edge 22, the trailing edge 24, and the pressure side 26. FIG. 2E illustrates an exemplary surface-modified airfoil 40 including surface features localized only at the leading edge 22 and the trailing edge 24. While the surface features are illustrated in various selected locations in at least a portion of the exterior surface of the airfoil, it is to be understood that the surface features may be in additional or alternative locations of the exterior surface of the airfoil. It is also to be understood that the surface features may have additional or alternative orientations. For example, while surface features that are generally oriented in a horizontal direction are depicted, it is to be understood that the surface features may be generally oriented in a vertical direction, or both vertical and horizontal.

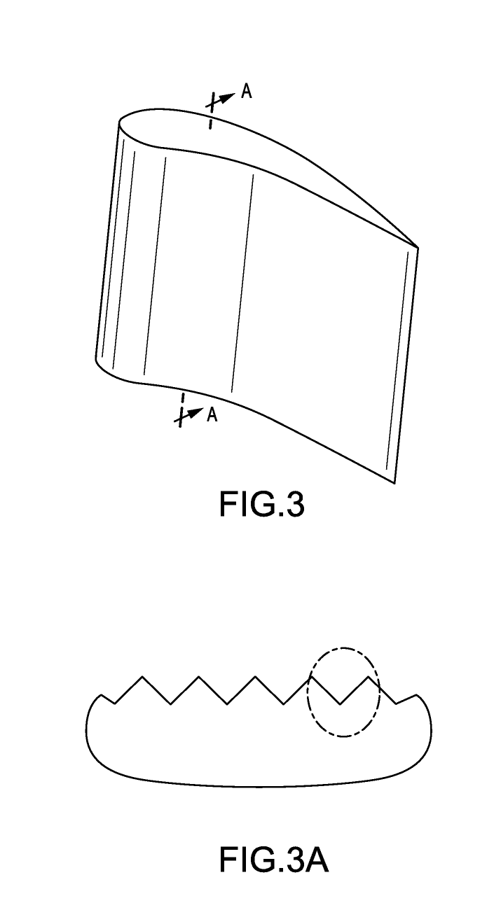

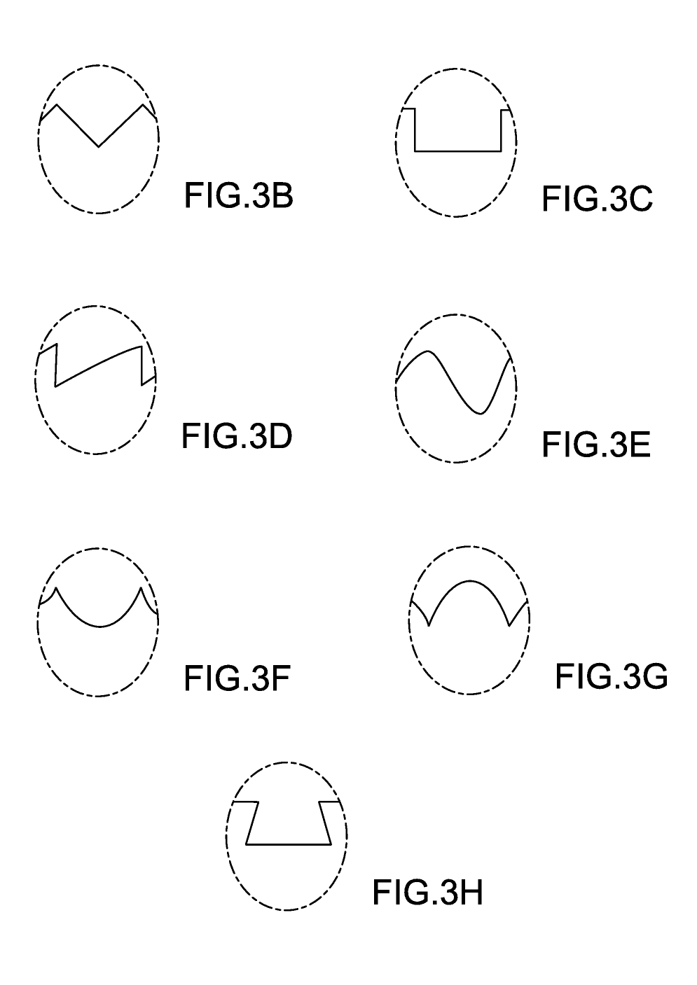

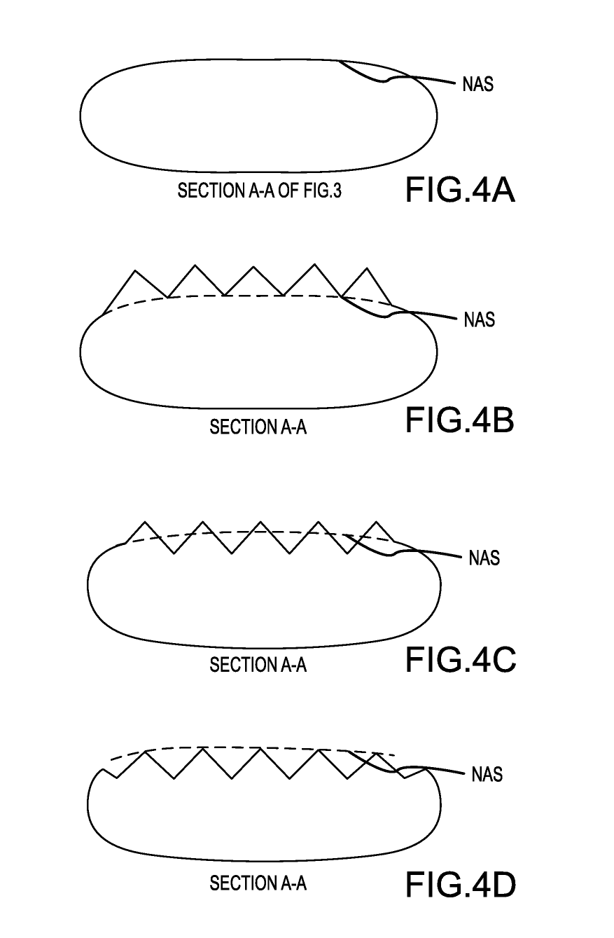

Referring now to FIG. 3 illustrating an exemplary surface-modified airfoil 40 and to FIG. 3B illustrating a section thereof taken along line A-A of FIG. 3, according to various embodiments, it is to be understood that the one or more surface features may comprise different shapes. Exemplary cross-sectional shapes of the one or more surface features are illustrated in FIG. 3B through FIG. 3H, according to various embodiments. Exemplary illustrated cross-sectional shapes of the surface feature include a triangular shape (FIG. 3B), a rectangular shape (FIG. 3C), a saw-tooth shape (FIG. 3D), a trigonometric function shape (e.g., cosines, sine, tangent, etc.) (a sine shape is depicted) (FIG. 3E), a conical shape (FIGS. 3F and 3G), or a dove-tail shape (FIG. 3H). It is to be understood that the surface feature may have a cross-sectional shape other than that depicted.

Still referring to FIG. 3 and now to FIGS. 4A through 4D illustrating a cross section of the surface-modified airfoil of FIG. 3, according to various embodiments, the surface feature 42 (such as surface feature 42a) may project outwardly from a nominal airfoil surface (NAS) (FIG. 4A) (“proud of” the nominal airfoil surface) (FIG. 4B), slightly project outwardly from the nominal airfoil surface (“semi-proud” of the nominal airfoil surface) (FIG. 4C), or be within the nominal airfoil surface as illustrated in FIG. 4D. Thus, the surface feature may project above the nominal airfoil surface or be within the nominal airfoil surface. Whether the surface feature is a depression feature or a protrusion feature is defined by the nominal airfoil surface.

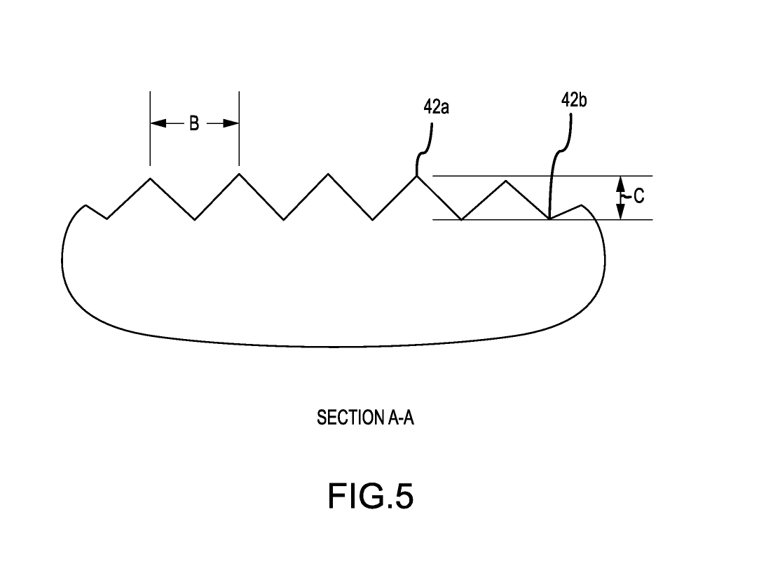

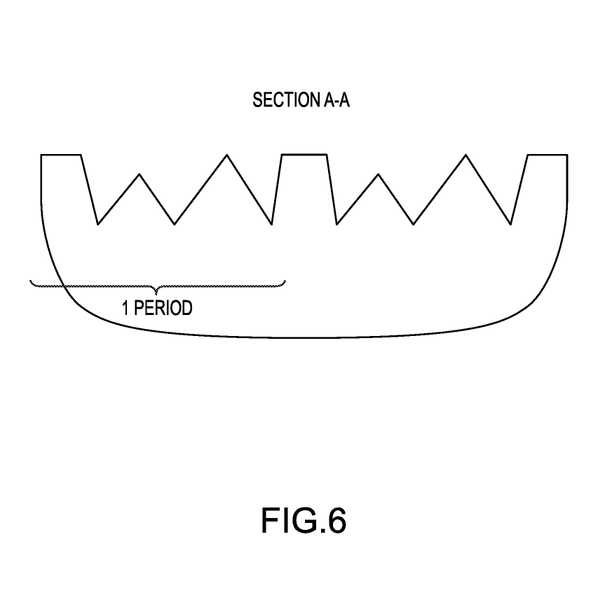

The surface feature 42a and 42b may have a selected cross-sectional shape and orientation as previously noted. In addition or alternatively, according to various embodiments, the surface feature may have a selected size, spacing (arrows B in FIG. 5), depth (arrows C in FIG. 5) and periodicity (FIG. 6), or combinations thereof. As hereinafter described, according to various embodiments, the surface feature may be selected to have a predetermined size, orientation, and cross-sectional shape to control a direction of incident energy reflected from the surface-modified airfoil. Thus, the surface feature may be operatively configured to control a direction of incident energy reflected from the surface-modified airfoil.

Referring now to FIGS. 7 through 9, the surface-modified airfoil 40 may further comprise one or more coatings (“a coating” or “the coating”) 44 on the exterior surface of at least the portion of the surface-modified airfoil 40. The surface-modified airfoil including the coating 44 comprises a coated surface-modified airfoil 50. The surface-modified airfoil without a coating is referred to herein as an “uncoated surface-modified airfoil.” The one or more surface features 42a and/or 42b may be used to provide better adherence of the coating 44 on the surface-modified airfoil. The surface feature may be operatively configured to anchor the coating on at least the portion of the exterior surface.

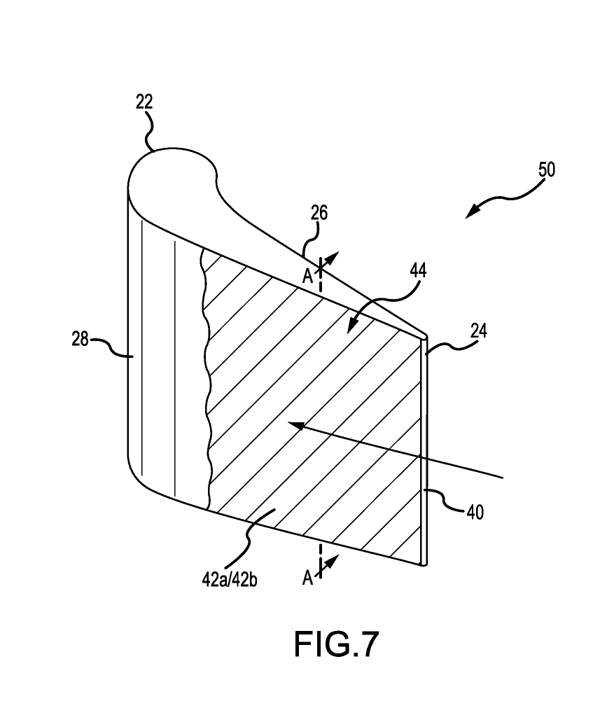

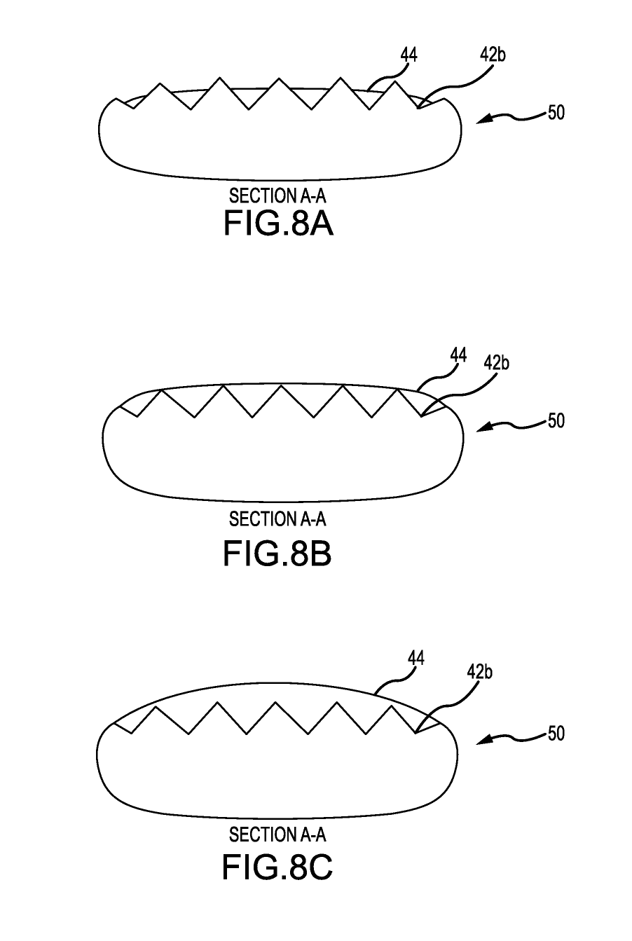

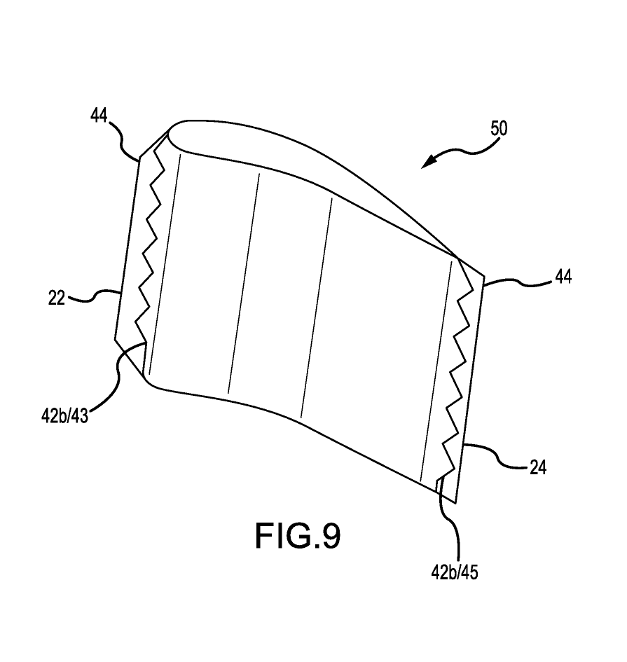

As shown in the sectional views of FIGS. 8A through 8C, according to various embodiments, the coating at least partially fills the depression feature. For example, FIG. 8A illustrates a partially filled depression feature, FIG. 8B illustrates fully filled depression feature, and FIG. 8C illustrates an over-filled depression feature. The coated surface-modified airfoil 50 may have varying levels of coating thickness and a substantially smooth exterior surface. For example, FIG. 9 depicts a coated surface-modified airfoil 50 comprising a first plurality of grooves 43 (exemplary depression features 42b) localized at the leading edge 22 of the coated surface-modified airfoil 50 and a second plurality of grooves 45 localized at the trailing edge 24 of the coated surface-modified airfoil 50 with one or more coatings 44 on the exterior surface thereof (including in the grooves 42b at the leading and trailing edge portions). Exemplary coatings may include, without limitation, a thermal barrier coating, an abrasion coating, an erosion coating, an energy management coating, a metallic coating, a ceramic coating, an aesthetic coating, a structural coating, and combinations thereof.

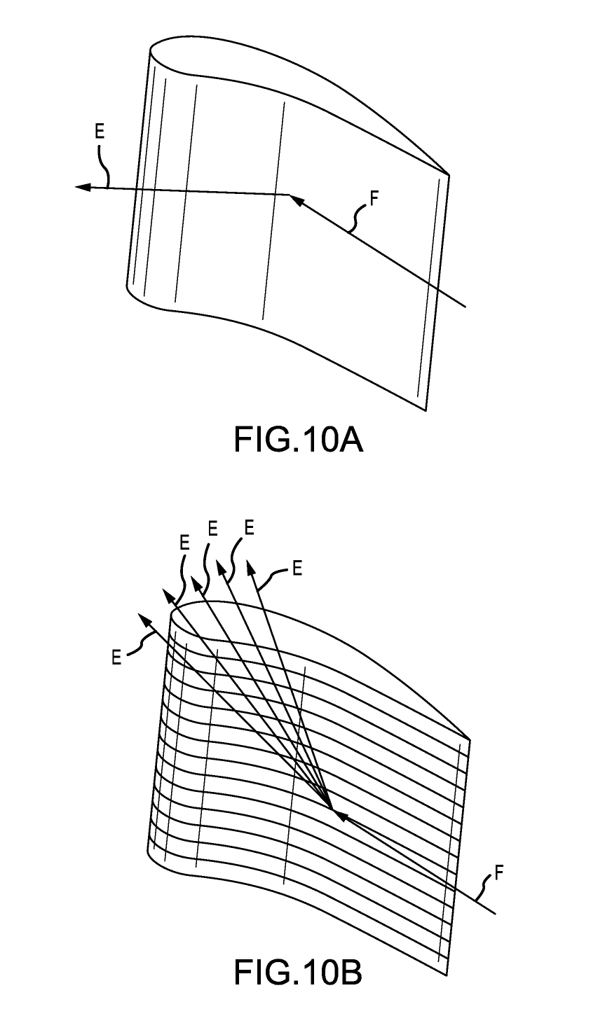

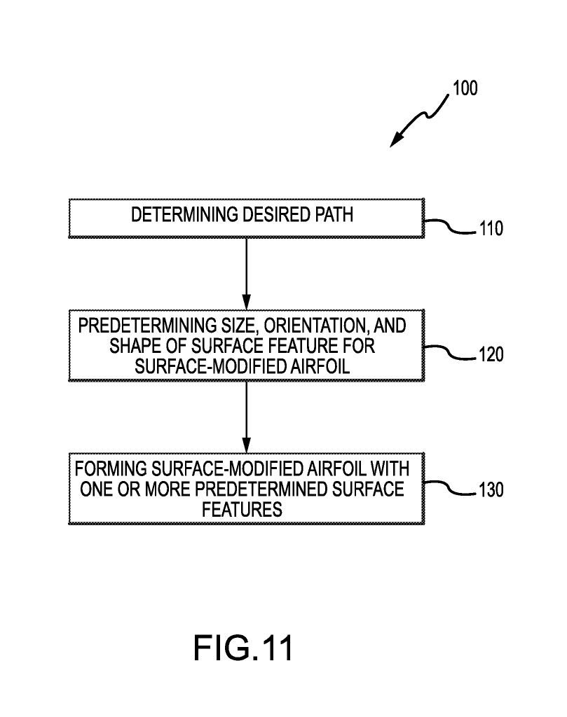

Referring now to FIGS. 10A, 10B, and 11, according to various embodiments, a method 100 for controlling a direction of incident energy reflection (indicated by arrow(s) E in FIGS. 10A and 10B) from the surface-modified airfoil 40 of a gas turbine engine component is now disclosed. When an incident energy wave (indicated by arrow F in FIGS. 10A and 10B) is incident upon the airfoil exterior surface, the result is the reflected incident energy wave (arrow(s) E). The incident energy wave F on a non-modified smooth airfoil surface conventionally reflects as shown in FIG. 10A according to Snell's Law. In order to follow the quickest path through a system, a wave changes direction as it travels from a medium of one refractive index to another medium that has a different refractive index. Snell's Law, which can be stated as: nA Sin θ A=nB Sin θ B. Snell's Law predicts how the wave will change direction as it passes from one medium into another, or as it is reflected from the interface between two media. The angles in this equation are referenced to a surface normal. As used herein, “incident energy” comprises at least one of internally and/or externally generated source of energy that is propagated into and/or out of the gas turbine engine. FIG. 10B illustrates the controlled (re)direction of the reflected incident energy waves (arrows E) in a managed and predictable path by forming a surface-modified airfoil 40 having the surface feature 42a/42b of a predetermined size, orientation, and shape as hereinafter described. The energy wave F incident on the surface-modified airfoil 40 reflects in a managed and predictable path according to the predetermined size, orientation, and shape of the one or more surface features 42a/42b as herein described.

Still referring to FIG. 11, according to various embodiments, the method 100 for controlling the direction of the reflected incident energy wave begins by determining a desired path for the reflected incident energy wave (step 110). The desired path may be in any desired direction toward and/or away from the airfoil.

The method 100 for controlling the direction of incident energy reflection from an airfoil begins by predetermining a size, an orientation and a shape of the one or more surface features that will (re)direct the reflected incident energy wave in the desired direction (step 120). The surface feature with the predetermined size, orientation, and shape is referred to herein as a “predetermined surface feature.”

Still referring to FIG. 11, according to various embodiments, the method 100 for controlling the direction of incident energy reflection from the airfoil continues by forming the surface-modified airfoil with the one or more predetermined surface features (step 130). The one or more predetermined surface features may be retrofitted to an airfoil or formed when the surface-modified airfoil is originally manufactured. If retrofitted, forming the predetermined surface feature comprises modifying the exterior surface of at least the portion of the airfoil to include the one or more predetermined surface features.

As a result of the predetermined surface feature, the reflected incident energy waves (arrows F in FIG. 10B) are transmitted or reflected from the airfoil surface in the desired (a managed and predictable) path determined in step 110. The one or more predetermined surface features controllably direct the incident energy reflection to the desired path. As noted above, the surface-modified airfoil 40 may further comprise the one or more coatings 44 to form the coated surface-modified airfoil 50. The one or more coatings may be selected so as to not hinder controlling the direction of incident energy reflection. For example, the coating may be transparent. The coating 44 may be selected to enhance durability of the coated surface-modified airfoil without affecting the ability to control the reflected incident energy wave(s) (arrow E in FIG. 10B).

From the foregoing, it is to be appreciated that various embodiments provide for a surface-modified airfoil and a coated surface-modified airfoil, the airfoil surface modified in a manner that helps one or more coatings adhere thereto, helps control the direction of incident energy reflection therefrom and, specifically for the coated surface-modified airfoils, provides a substantially smooth contact surface for aerodynamic purposes but with varying coating thickness levels.

Benefits, other advantages, and solutions to problems have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Different cross-hatching is used throughout the figures to denote different parts but not necessarily to denote the same or different materials.

Systems, methods and apparatus are provided herein. In the detailed description herein, references to “one embodiment”, “an embodiment”, “various embodiments”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element herein is to be construed under the provisions of 35 U.S.C. 112(f) unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A surface-modified airfoil for a gas turbine engine component, the surface-modified airfoil comprising:
an airfoil having an exterior surface on a leading edge, a trailing edge, a suction side, and a pressure side; and
a surface feature in at least a portion of the exterior surface, the surface feature comprising at least one of a protrusion feature or a depression feature operatively configured for one of anchoring a coating on at least the portion of the exterior surface or controlling a direction of incident energy reflected from the surface-modified airfoil.

2. The surface-modified airfoil of claim 1, wherein the surface feature partially extends between the leading edge and the trailing edge.

3. The surface-modified airfoil of claim 1, wherein the surface feature is localized on at least one of the leading edge of the airfoil, the trailing edge of the airfoil, a position upstream from the trailing edge of the airfoil, a position downstream from the leading edge of the airfoil, on the pressure side of the airfoil, or on the suction side of the airfoil.

4. The surface-modified airfoil of claim 1, wherein the surface feature comprises other than a groove and extends continuously from the leading edge to the trailing edge of the airfoil, on at least one of the pressure side or the suction side of the airfoil.

5. The surface-modified airfoil of claim 1, wherein the surface feature at least one of projects above a nominal airfoil surface of the exterior surface or is within the nominal airfoil surface.

6. The surface-modified airfoil of claim 1, wherein the surface feature has at least one of a cross-sectional shape comprising a triangular shape, a rectangular shape, a saw-tooth shape, a trigonometric function shape, a conical shape, or a dove tail shape.

7. The surface-modified airfoil of claim 1, wherein the surface feature is arranged in a straight line and has an orientation in one direction or a curved orientation in one or more directions.

8. The surface-modified airfoil of claim 1, wherein the surface feature has at least one of a selected depth, a selected spacing, or a selected periodicity.

9. The surface-modified airfoil of claim 8, wherein the surface feature is selected to have a predetermined size, orientation, and cross-sectional shape to control the direction of incident energy reflected from the surface-modified airfoil.

10. The surface-modified airfoil of claim 1, further comprising the coating on at least the portion of the airfoil and the surface-modified airfoil comprises a coated surface-modified airfoil.

11. The surface-modified airfoil of claim 10, wherein the surface feature comprises a groove extending from the leading edge to the trailing edge.

12. The surface-modified airfoil of claim 10, wherein the coating at least partially fills the surface feature.

13. A gas turbine engine component comprising:
a surface-modified airfoil comprising:
an airfoil having an exterior surface at a leading edge, a trailing edge, a suction side, and a pressure side; and
a surface feature in at least a portion of the exterior surface, the surface feature comprising at least one of a protrusion feature or a depression feature.

14. The gas turbine engine component of claim 13, further comprising a coating on at least the portion of the exterior surface of the surface-modified airfoil.

15. The gas turbine engine component of claim 13, wherein at least one of:
the surface feature partially extends between the leading edge and the trailing edge;
the surface feature is localized on at least one of the leading edge of the airfoil, the trailing edge of the airfoil, a position upstream from the trailing edge of the airfoil, a position downstream from the leading edge of the airfoil, on the pressure side of the airfoil, or on the suction side of the airfoil; and
the surface feature comprises other than a groove and extends continuously from the leading edge to the trailing edge of the airfoil, on at least one of the pressure side or the suction side of the airfoil.

16. The gas turbine engine component of claim 13, wherein the surface feature at least one of projects above a nominal airfoil surface or is within the nominal airfoil surface and has an orientation in one direction or a curved orientation in one or more directions.

17. The gas turbine engine component of claim 13, wherein the surface feature is selected to have a predetermined size, orientation, and cross-sectional shape to control a direction of incident energy reflected from the surface-modified airfoil.

18. A method for controlling a direction of incident energy reflection from an airfoil of a gas turbine engine component, the method comprising:
determining a desired path for the incident energy reflection;
predetermining a size, orientation, and shape of a surface feature in at least a portion of an exterior surface of the airfoil to controllably direct the incident energy reflection to the desired path; and
forming a surface-modified airfoil having the surface feature of the predetermined size, orientation, and shape.

19. The method of claim 18, wherein forming a surface-modified airfoil comprises forming the surface feature in at least one portion of the exterior surface of the airfoil, the surface feature comprising at least one of a protrusion feature or a depression feature.

20. The method of claim 19, wherein forming a surface-modified airfoil comprises forming the surface feature in the at least one portion comprising a selected portion at least partially extending between a leading edge and a trailing edge of the airfoil or localized on at least one of the leading edge of the airfoil, the trailing edge of the airfoil, a position upstream from the trailing edge of the airfoil, a position downstream from the leading edge of the airfoil, on the pressure side of the airfoil, or on the suction side of the airfoil.
